(19) United States
(12) Patent Application Publication
(10) Pub. No.: US 2019/0011366 A1
(43) Pub. Date: Jan. 10, 2019

(54) BIOSENSOR

(71) Applicant: Shenzhen Genorivision Technology Co., Ltd., Shenzhen (CN)

(72) Inventors: Peiyan CAO, Shenzhen (CN); Rui DING, Shenzhen (CN); Yurun LIU, Shenzhen (CN)

(21) Appl. No.: 16/117,998

(22) Filed: Aug. 30, 2018

Related U.S. Application Data
(63) Continuation of application No. PCT/CN2016/086515, filed on Jun. 21, 2016.

(51) Int. Cl. G01N 21/64; G01N 21/77

(52) U.S. Cl. CPC G01N 21/6458; G01N 21/648; G01N 2201/0638; G01N 2021/6463; G01N 21/7703

(57) ABSTRACT

Disclosed herein is an apparatus comprising: a probe carrier comprising a plurality of optical waveguides supported on a substrate; wherein each of the plurality of optical waveguides is optically decoupled from another of the plurality of optical waveguides; wherein each of the plurality of optical waveguides comprises a surface comprising sites configured to attach a probe.

### TECHNICAL FIELD

The disclosure herein relates to biosensors, particularly biosensors based on optical detection.

### BACKGROUND

A biosensor is an analytical device for detection of an analyte involved in a biological process. For example, the analyte may be a DNA, a protein, a metabolite, or even a living organism (e.g., bacteria, virus).

A biosensor usually has a probe that interacts with the analyte. The probe may be designed to bind or recognize the analyte. Examples of the probe may include antibodies, aptamers, DNAs, RNAs, antigens, etc. Interaction between the probe and the analyte may lead to one or more detectable event. For example, the detectable event may be release of a chemical species or a particle (e.g., a quantum dot), a chemical reaction, luminescence (e.g., chemiluminescence, bioluminescence, electrochemiluminescence, electroluminescence, photoluminescence, fluorescence, and phosphorescence), change in a physical property (e.g., Raman scattering, color) or chemical property (e.g., reactivity, reaction rate).

A biosensor may have a detector that can detect the detectable event as a result of the interaction. The detector may transform the detectable event into another signal (e.g., image, electrical signal) that can be more easily measured and quantified. The detector may include circuitry that obtains data from the detectable event and processes the data.

One type of biosensor is microarrays. A microarray can be a two-dimensional array on a solid substrate (e.g., a glass slide, a silicon wafer). The array may have different assays at different locations. The assays at different locations may be independent controlled or measured, thereby allowing multiplexed and parallel sensing of one or many analytes. A microarray may be useful in miniaturizing diagnosis assays. For example, a microarray may be used for detecting biological samples in the fields without sophisticated equipment, or be used by a patient who is not in a clinic or hospital to monitor his or her physiological symptoms.

### SUMMARY

Disclosed herein is an apparatus comprising: a probe carrier comprising a plurality of optical waveguides supported on a substrate; wherein each of the plurality of optical waveguides is optically decoupled from another of the plurality of optical waveguides; wherein each of the plurality of optical waveguides comprises a surface comprising sites configured to attach a probe.

According to an embodiment, a refractive index of at least one of the plurality of optical waveguides is greater than a refractive index of water.

According to an embodiment, two of the plurality of optical waveguides have different reflective indexes.

According to an embodiment, two of the plurality of optical waveguides have same reflective indexes.

According to an embodiment, cross-sectional shape of the plurality of optical waveguides is a rectangle, a square, a triangle, of a semi-circle.

According to an embodiment, the plurality of optical waveguides are parallel to one another.

According to an embodiment, space among the optical waveguides is filled with a material.

According to an embodiment, the plurality of optical waveguide comprise a material selected from a group consisting of: glass, quartz, diamond, an organic polymer, and a composite thereof.

According to an embodiment, the sites are configured to directly attach to the probe through physical adsorption, chemical crosslinking, electrostatic adsorption, hydrophilic interaction or hydrophobic interaction.

According to an embodiment, the probe is selected from a group consisting of fluorescently proteins, peptides, oligonucleotides, cells, bacteria, and nucleic acids.

According to an embodiment, the probe comprises an internal luminophore.

According to an embodiment, the substrate comprises silicon.

According to an embodiment, the apparatus comprises an optical system, the optical system comprising a plurality of collimators; wherein the collimators are configured to essentially prevent light from passing if a deviation of a propagation direction of the light from an optical axis of the collimators is greater than a threshold.

According to an embodiment, the apparatus comprises a sensor which comprises a plurality of pixels configured to detect a signal generated by the apparatus.

According to an embodiment, the sensor comprises a control circuit configured to control, acquire data from, or process data from the pixels.

According to an embodiment, the pixels are arranged such that at least one of the pixels is optically coupled to each of the sites.

According to an embodiment, the pixels are optically coupled to the sites by the collimators.

According to an embodiment, the signal is luminescence.

According to an embodiment, the signal is generated under excitation of an excitation radiation.

According to an embodiment, the optical system further comprises a plurality of microlens.

According to an embodiment, the collimators are configured to eliminate optical cross-talk between neighboring pixels among the plurality of pixels.

According to an embodiment, at least one of the collimators comprises a core and a sidewall surrounding the core.

According to an embodiment, the signal is generated under excitation of an excitation radiation; wherein the core is a material that essentially prevents the excitation radiation from passing through irrespective of propagation direction of the excitation radiation.

According to an embodiment, the core allows the signal to pass through essentially unabsorbed.

According to an embodiment, the core is a void space.

According to an embodiment, the sidewall attenuates a portion of the signal reaching the sidewall.

According to an embodiment, the sidewall is textured.

According to an embodiment, the pixels are arranged in an array and are configured to be read out column by column.

According to an embodiment, the pixels are arranged in an array and are configured to be read out pixel by pixel.

Disclosed herein is a total internal reflection fluorescence microscope (TIRFM) comprising any of the above apparatuses.

### BRIEF DESCRIPTION OF FIGURES

FIG. 1A schematically shows a probe carrier of a biosensor.

FIG. 1B schematically shows a cross-sectional view of the probe carrier of FIG. 1A.

FIG. 2 schematically shows a probe carrier of a biosensor, according to an embodiment.

FIG. 3 schematically shows a cross sectional view of a probe carrier, according to an embodiment.

FIG. 4 schematically shows a cross sectional view of a probe carrier with a filling material, according to an embodiment.

FIG. 5A-FIG. 5D schematically illustrates a method of making a waveguide layer with a plurality of optical waveguides on a substrate.

FIG. 6 schematically shows an apparatus comprising a probe carrier such as the probe carrier of FIG. 2, according to an embodiment.

FIG. 7A schematically shows an apparatus comprising a probe carrier, such as the probe carrier of FIG. 2, according to an embodiment.

FIG. 7B schematically shows an apparatus comprising microlens and a probe carrier, according to an embodiment.

FIG. 8A schematically shows a collimator, according to an embodiment.

FIG. 8B schematically shows a collimator, according to an embodiment.

FIG. 8C and FIG. 8D each schematically show that the optical system may have a plurality of collimators arranged in an array, according to an embodiment.

FIG. 8E schematically shows an apparatus in which the optical system may have a microfluidic system, according to an embodiment.

FIG. 9A schematically shows an apparatus wherein a sensor in a microarray may have a signal transfer layer and that the optical system in the microarray may have a redistribution layer, according to an embodiment.

FIG. 9B schematically shows a top view of the sensor in FIG. 9A.

FIG. 9C schematically shows a bottom view of the optical system in FIG. 9A.

FIG. 10A schematically shows an apparatus wherein a sensor in a microarray may have a redistribution layer and that the optical system in the microarray may have a signal transfer layer, according to an embodiment.

FIG. 10B schematically shows a top view of the sensor in FIG. 10A, according to an embodiment.

FIG. 10C schematically shows a bottom view of the optical system in FIG. 10A, according to an embodiment.

FIG. 10D schematically shows a top view of the sensor in FIG. 10A, according to an embodiment.

FIG. 10E schematically shows a bottom view of the optical system in FIG. 10A to illustrate the positions of the bonding pads, which are positioned to connect to the vias shown in FIG. 10D.

FIG. 10F schematically shows a top view of the sensor in FIG. 10A, according to an embodiment.

FIG. 10G schematically shows a bottom view of the optical system in FIG. 10A to illustrate the positions of the bonding pad, which are positioned to connect to the via shown in FIG. 10F.

FIG. 11 schematically shows that system 1100 wherein a sensor in a microarray may have a redistribution layer with vias such as through-silicon vias (TSV) configured to electrically connect the transmission lines in the redistribution layer to bonding pads on the side opposite from the redistribution layer, according to an embodiment.

FIG. 12 schematically shows that system of total internal reflection fluorescence microscope (TIRFM).

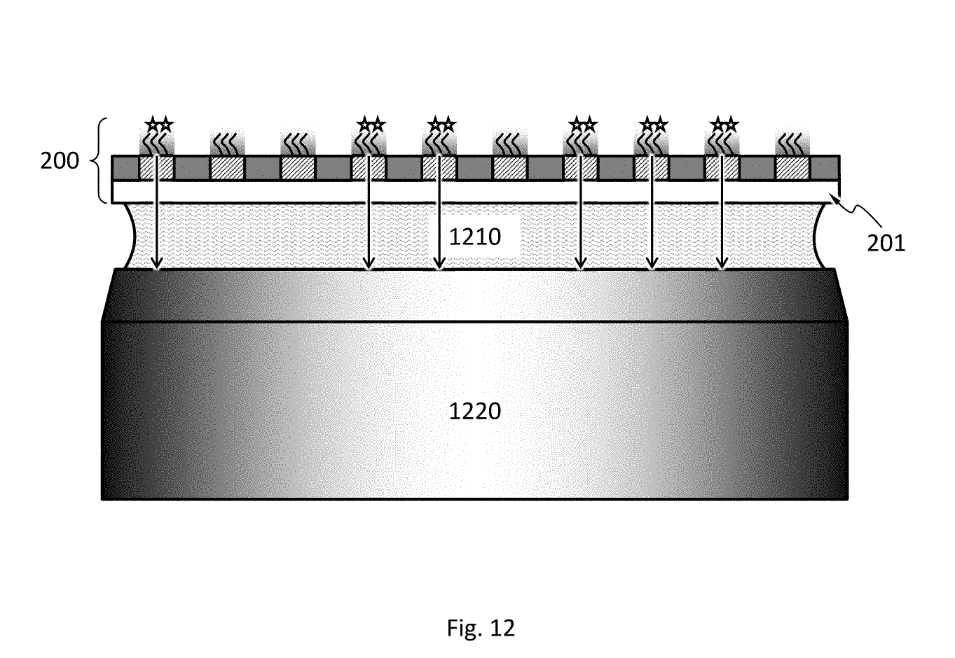

### DETAILED DESCRIPTION

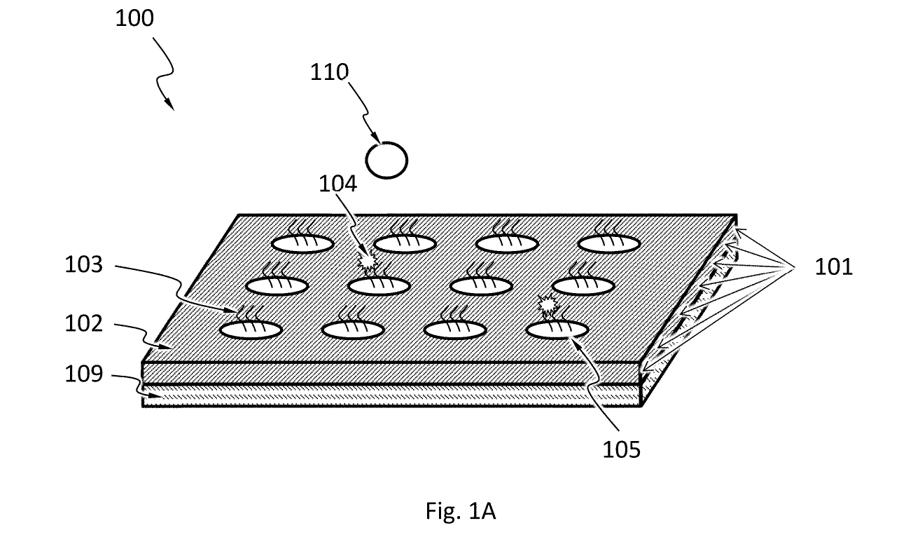

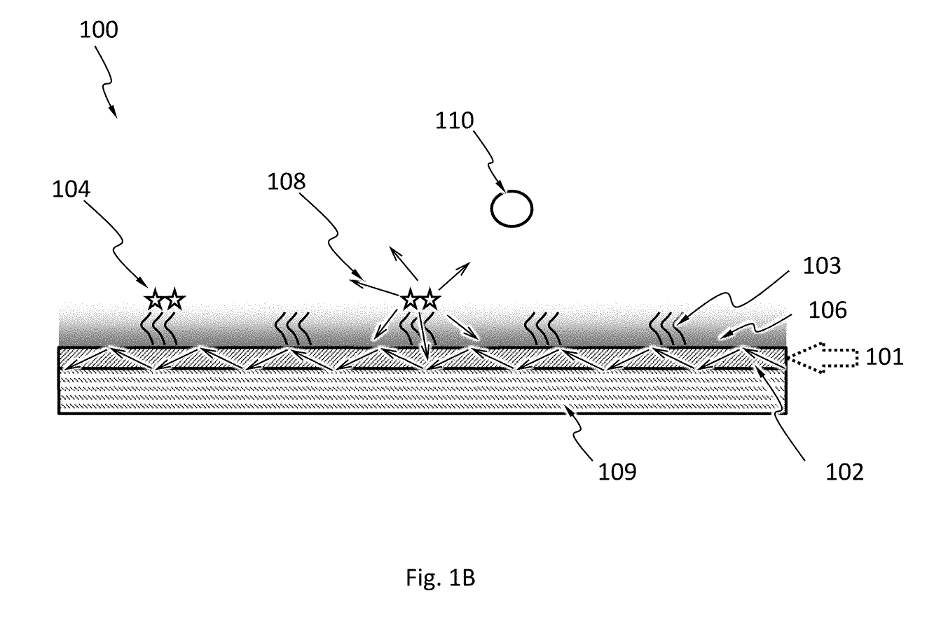

FIG. 1A illustrates a probe carrier 100 of a biosensor. The probe carrier 100 comprises a sheet of optical waveguide 102. A laser 101 is coupled to the sheet of optical waveguide 102 from its edge. To facilitate the coupling, the laser 101 is spread from a beam to a sheet. A sheet of laser may be produced by spreading a laser beam in only one direction. The sheet of laser is directed to an edge of the sheet of optical waveguide 102 to couple the laser into the sheet of optical waveguide 102. A plurality of probes 103 are attached to sites 105 at a surface of the sheet of optical waveguide 102. The probes 103 may interact with analytes 110 in a sample in contact with the probes 103, and the interaction may generate a signal 104 under the excitation of the laser propagating in the sheet of optical waveguide 102. The sheet of optical waveguide 102 may be placed on a substrate 109. The combination of the sheet of optical waveguide 102 and the substrate 109 may be called a probe carrier.

FIG. 1B shows a cross-sectional view of the probe carrier 100 of FIG. 1A. The laser 101 coupled into the sheet of optical waveguide 102 undergoes total internal reflection at least at the surface to which the probes 103 are attached. The evanescent wave 106 outside this surface of the sheet of optical waveguide 102 can excite the probes 103 interacting with the analytes 110, thereby generating the signal 104. As used herein, total internal reflection refers to a phenomenon which occurs when a propagating wave strikes a medium boundary at an angle larger than a particular critical angle with respect to the normal to the surface. If the refractive index is lower on the other side of the boundary and the incident angle is greater than the critical angle, the wave cannot pass through and is entirely reflected. The critical angle is the angle of incidence above which the total internal reflection occurs. There are two necessary conditions for total internal reflection: incident light wave travels from an optically dense medium to an optically less dense media, and the incident angle must be greater than or equal to a critical angle. An important effect of total internal reflection is the appearance of an evanescent wave beyond the boundary surface. Essentially, even though the entire incident wave is reflected back into the originating medium, the evanescent wave penetrates into the second medium at the boundary. The evanescent wave appears to travel along the boundary between the two materials and then returns into the optically dense medium. The evanescent wave is characterized by its propagation in a parallel direction of the interface and its exponential attenuation in a direction perpendicular to the interface. The 1/e-penetration distance in the direction perpendicular to the interface can be several hundred nanometers. As shown in FIG. 1B, the probes 103 located within the reach of the evanescent wave 106 (as shown by the grey color in gradient) may be excited by the evanescent wave 106 and generate a signal 104. The signal may transmit in a variety of directions 108. The intensity of the signal 104 is proportional to the amount of analytes 110. By detecting the intensity of the signal 104, the amount of the analytes 110 in a biological sample of interest can be calculated.

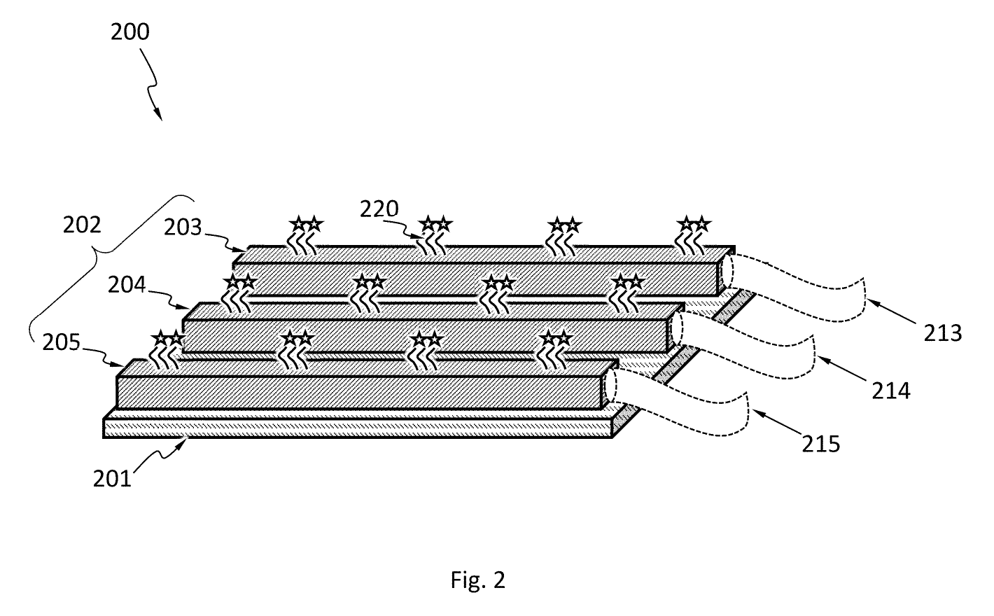

FIG. 2 illustrates a probe carrier 200 of a biosensor according to an embodiment. As shown in FIG. 2, the probe carrier 200 comprises an optical waveguide layer 202 on a substrate 201. The optical waveguide layer 202 may comprise a plurality of optical waveguides 203, 204 and 205 and each of the plurality of optical waveguides is optically decoupled from another of the plurality of optical waveguides. The optical waveguides such as 203, 204 and 205 may be in a shape of a band or a strip. The optical waveguides such as 203, 204 and 205 may be straight or curved. The optical waveguides such as 203, 204 and 205 may be arranged parallel to one another. The substrate 201 may be planar or nonplanar. Light (e.g., laser) for exciting probes attached to the waveguides may be coupled into the waveguides by optical fibers such as 213, 214 and 215 connected to end surfaces of the waveguides. The combination of the optical waveguide layer 202 and the substrate 201 may be called a probe carrier.

The optical waveguides such as 203, 204 and 205 may be arranged in any formation such as an array with a periodicity or an ensemble without a periodicity. The optical waveguides such as 203, 204 and 205 may be parallel to one another, or nonparallel to one another. The optical waveguides such as 203, 204 and 205 may have any suitable cross-sectional shape, such as a rectangle, a square, a triangle, a semi-circle or a polygon.

As shown in FIG. 2, each of the plurality of optical waveguides such as 203, 204 and 205 comprises a surface with sites configured to attach probes 220. Compared to a sheet of optical waveguide like 102 in FIG. 1A and FIG. 1B, an optical waveguide layer 202 with a plurality of optical waveguides may accommodate higher density of the probes 220 without the risk of crosstalk. If two probes attached to a sheet of optical waveguide like 102 are too close to each other, determining which one produces an observed signal may be difficult because all the probes attached to the sheet of optical waveguide are exposed to the light coupled into the sheet and any probe may generate the observed signal. In contrast, the light coupled into the optical waveguides of the optical waveguide layer 202 may be selectively turned on or off. If two probes are attached to two different optical waveguides (e.g., 203 and 204) of the optical waveguide layer 202, the light coupled into one (e.g., 203) of the two different optical waveguides may be turned off while the light coupled into the other (e.g., 204) of the two different optical waveguides remains on. Therefore, the probe attached to the one (e.g., 203) optical waveguide with the light coupled thereto turned off cannot generate the observed signal and the observed signal from the two probes must be generated by the probe attached to the other (e.g., 204) optical waveguide with the light coupled thereto turned on.

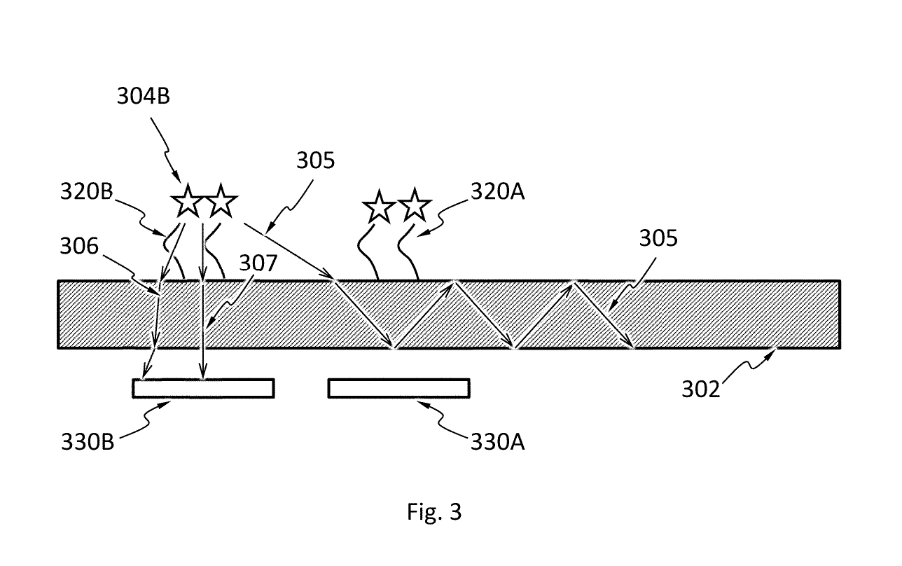

Cross-talks between probes on the same optical waveguide may also be reduced by the optical waveguide. FIG. 3 schematically illustrates a cross-sectional view of a long side of an optical waveguide 302. Two probes 320A and 320B are attached to different sites of the same optical waveguide 302. There are two detectors 330A and 330B positioned directly below the probes 320A and 320B, respectively. The detectors 330A and 330B are configured to respectively detect signals the probes 320A and 320B generate from interaction with an analyte. However, a portion 305 of the signal 304B generated by the probe 320B may propagate toward the detector 330A. If the portion 305 reaches the detector 330A, crosstalk occurs and the signal detected by the detector 330A will be interpreted as being from the probe 320A, thereby causing an error. The optical waveguide 302 may trap by total internal reflection the portion 305 in the optical waveguide 302 due to the relatively large angle of incidence of the portion 305, thereby preventing crosstalk with the neighboring probe 320A. Other portions (e.g., 306 and 307) of the signal 304B that have relatively small angles of incidence may travel through the optical waveguide 302 and be collected by the detector 330B.

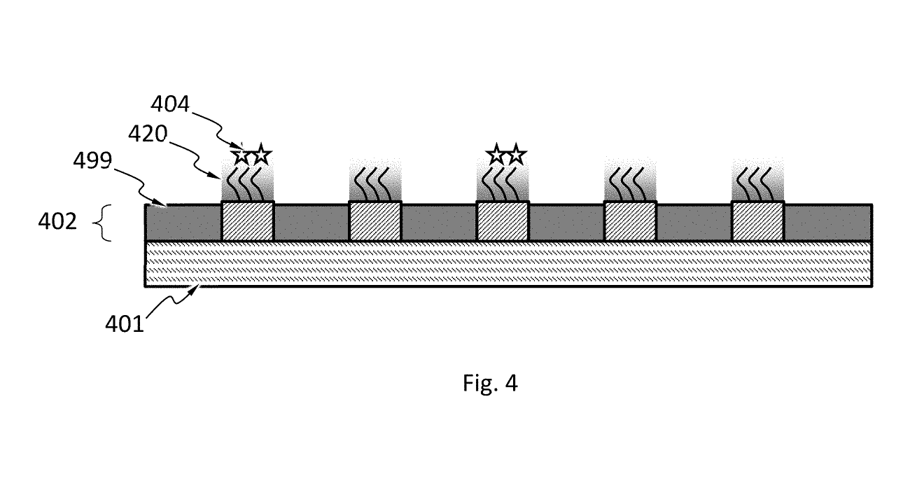

FIG. 4 schematically illustrates a cross-sectional view from a short side of a plurality of optical waveguides in a waveguide layer 402 of a probe carrier, the waveguide layer 402 being on a substrate 401. The space between the plurality of optical waveguides may be filled with a material 499 that is opaque to the signal 404 coming from interaction of probes 420 attached to the optical waveguides with an analyte. The material 499 may be filled in between the optical waveguides.

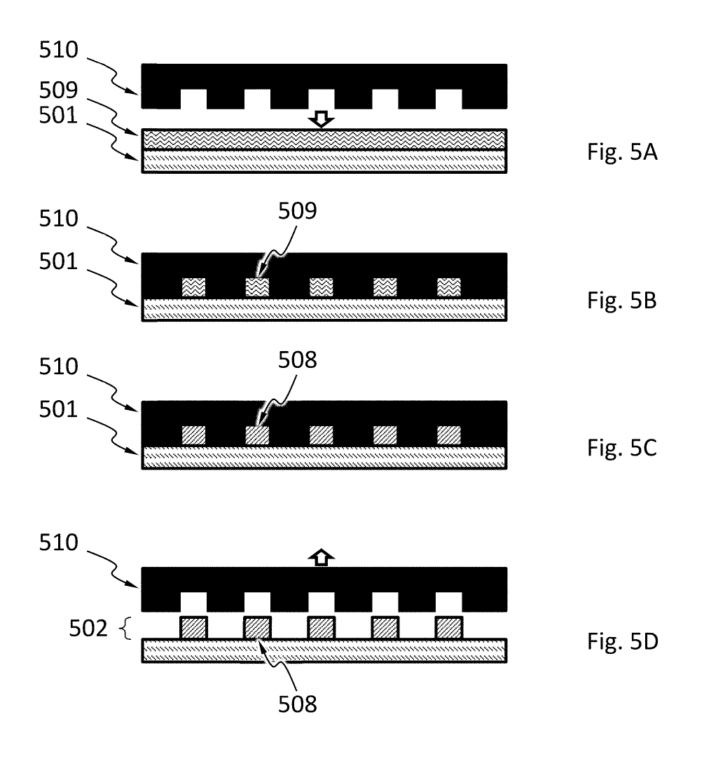

FIG. 5A-FIG. 5D schematically illustrates a method of making a waveguide layer with a plurality of optical waveguides on a substrate. FIG. 5A shows that a mold 510 is pressed into a layer of precursor 509 on a substrate 501. FIG. 5B shows that precursor 509 flows into recesses in the mold 510. FIG. 5C shows that the precursor 509 is cured to form the plurality of optical waveguides 508 while the mold 510 is still pressed against the substrate 501. FIG. 5D shows that the mold 510 is released from the substrate 501, leaving behind the plurality of optical waveguides 508 arranged in a waveguide layer 502.

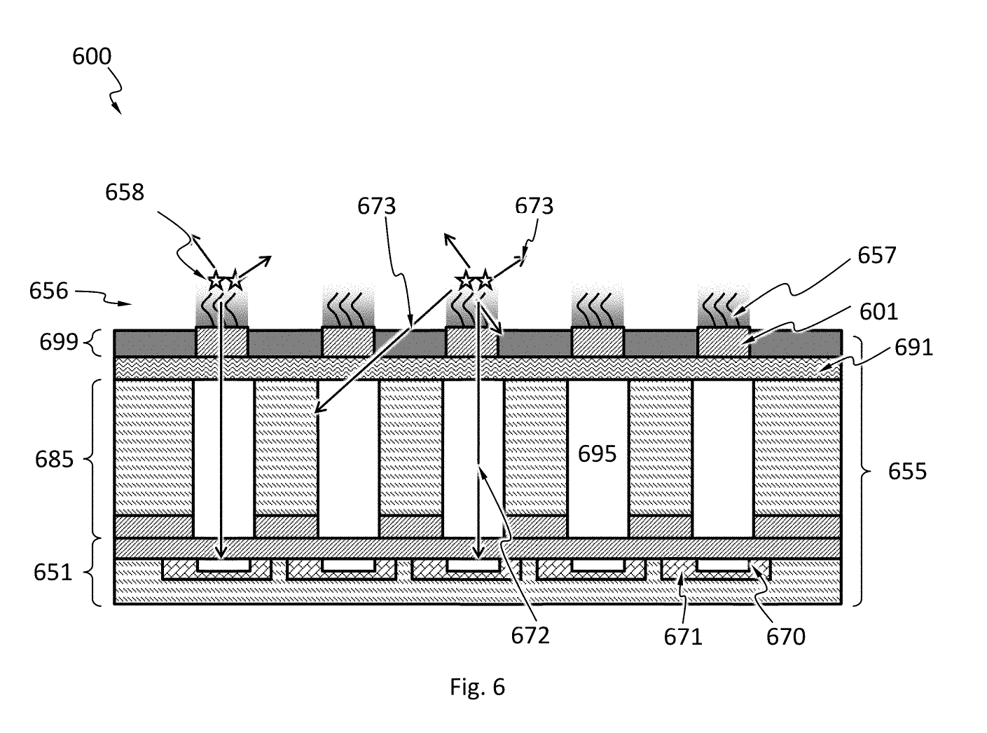

FIG. 6 schematically shows an apparatus 600 comprising a probe carrier, such as the probe carrier 200 as shown in FIG. 2, according to an embodiment. The apparatus 600 comprises a microarray 655 comprising a plurality of optical waveguides 601 arranged in a waveguide layer 699 on a substrate 691, an integrated sensor 651 and an optical system 685. The microarray 655 may have multiple sites 656 on the optical waveguides 601 with various probes 657 attached thereto. The probes 657 may interact with various analytes and the interaction may generate signals 658 detectable by the sensor 651. The sensor 651 may have multiple pixels 670 configured to detect the signals 658 (e.g., color, intensity). The pixels 670 may have a control circuit 671 configured to control, acquire data from, and/or process data from the pixels 670. The pixels 670 may be arranged such that each pixel 670 is optically coupled to one or more of the sites 656. The substrate 691 is transparent to the signals 658. The optical system 685 may include a plurality of collimators 695 configured to optically couple the pixels 670 to the sites 656. In an embodiment, the sensor 651 comprises quantum dots.

In an embodiment, the substrate 691 may include oxide or nitride. For example, the substrate 691 may include glass. In an embodiment, the substrate 691 may even be omitted.

In other embodiments, other types of microarrays may be used with any of the aforementioned probe carriers to form a biosensor apparatus. Some examples of such microarrays are illustrated as below.

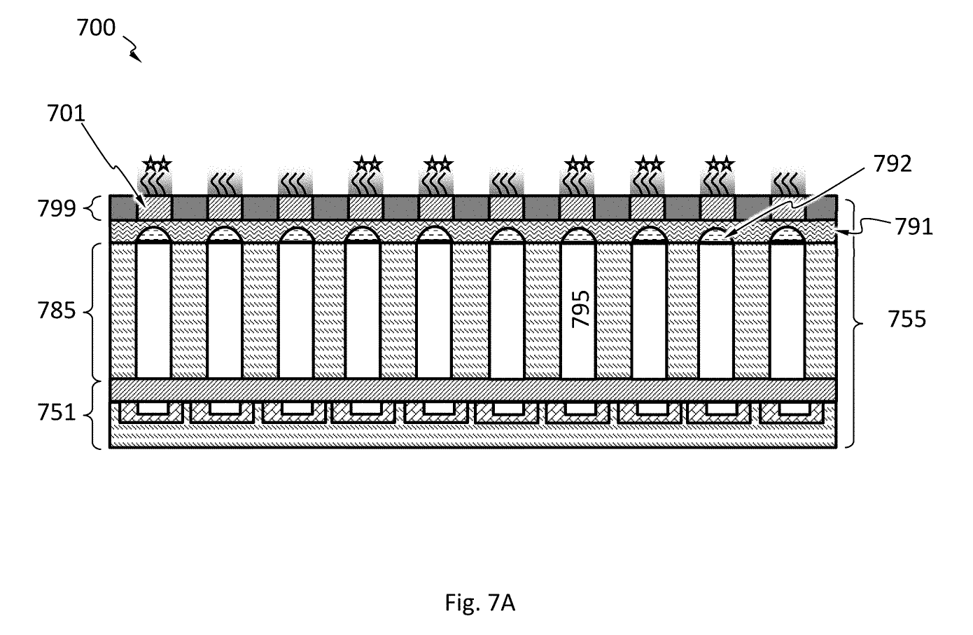

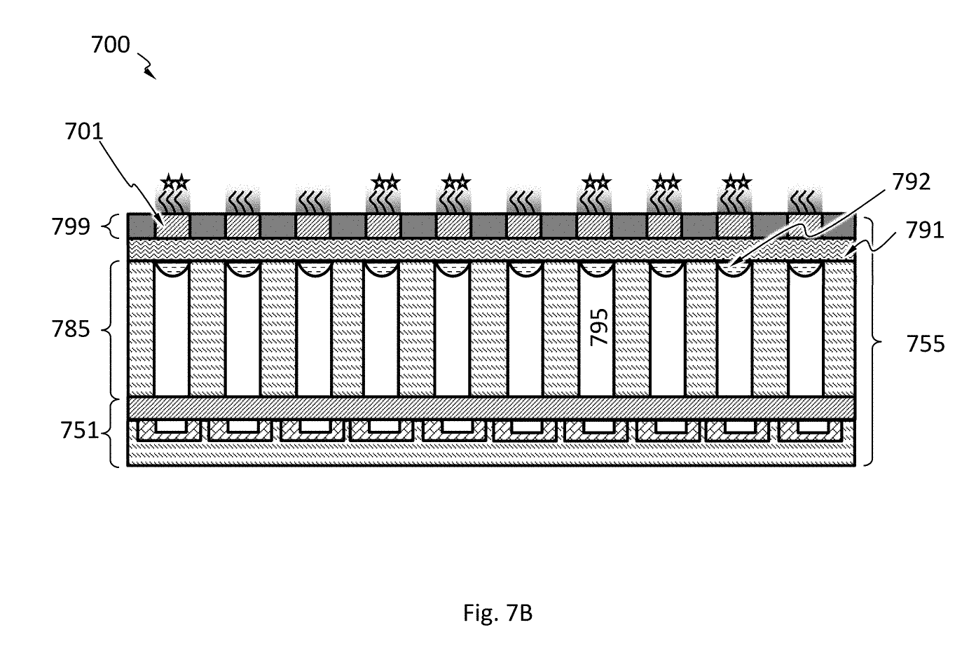

FIGS. 7A and 7B schematically shows an apparatus 700 comprising a probe carrier, such as the probe carrier 200 as shown in FIG. 2, according to an embodiment. As shown in FIG. 7A and FIG. 7B, the apparatus 700 comprises a microarray 755 comprising a plurality of optical waveguides 701 arranged in a waveguide layer 799 on a substrate 791, an integrated sensor 751 and an optical system 785, and the optical system 785 may have a plurality of microlens 792. The microlens 792 may be fabricated in the substrate 791 as shown in FIG. 7A. Alternatively, the microlens 792 may be fabricated in the collimators 795 as shown in FIG. 7B. The microlens 792 may be configured to focus light generated by the probes into the collimators 795. The microlens 792 may be configured to direct a greater portion of luminescence signal from probes into the pixels coupled thereto.

In embodiments as shown in FIG. 6, FIG. 7A and FIG. 7B, each site is aligned with one of the collimators. This is achieved by controlled fabrication process such that the holes in the probe carrier has a same width as the width of the collimators in the microarray, and appropriate alignment of the probe carrier with the microarray is required during assembly of the probe carrier with the microarray to form the biosensor apparatus.

In an embodiment, the optical waveguides 601 or 701, the substrate 691 or 791, the microlens 792 if present and the collimator 695 or 795 may be integrated on the same substrate.

In an embodiment, the collimator 695 or 795 may be configured to essentially prevent (e.g., prevent more than 90%, 99%, or 99.9% of) light from passing if the deviation of the propagation direction of the light from an optical axis of the collimator 695 or 795 is greater than a threshold (e.g., 20°, 10°, 5°, or 1°). Such as shown in FIG. 6, a portion 672 of the signals 658 may propagate toward the pixel 670 optically coupled to that location 656 but another portion 673 may be scattered towards neighboring pixels (“optical cross-talk”) and/or away from all pixels 670. The collimator 695 may be configured to essentially eliminate optical cross-talk by essentially preventing the portion 673 from passing through the collimator 695.

In an embodiment, each of the collimators 695 or 795 extends from one of the sites 656 to the pixel 670 optically coupled to that one location.

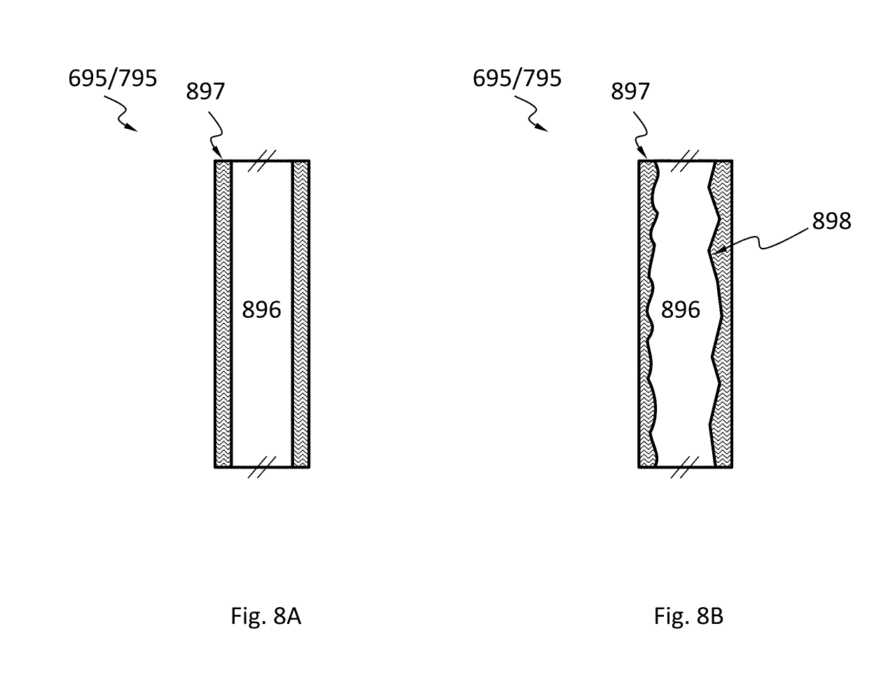

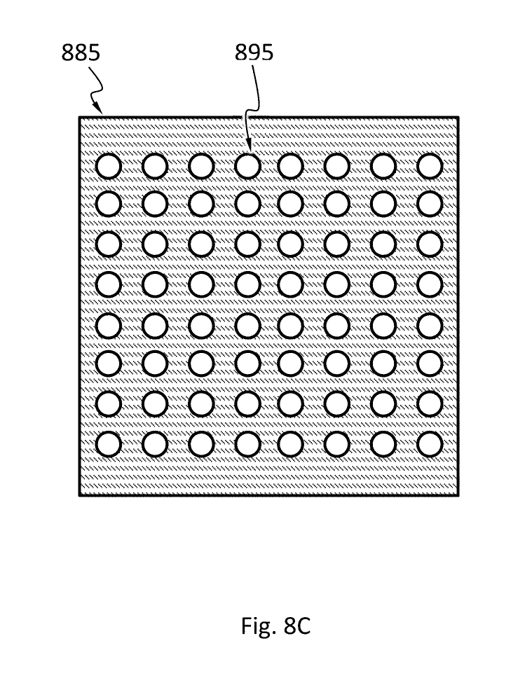

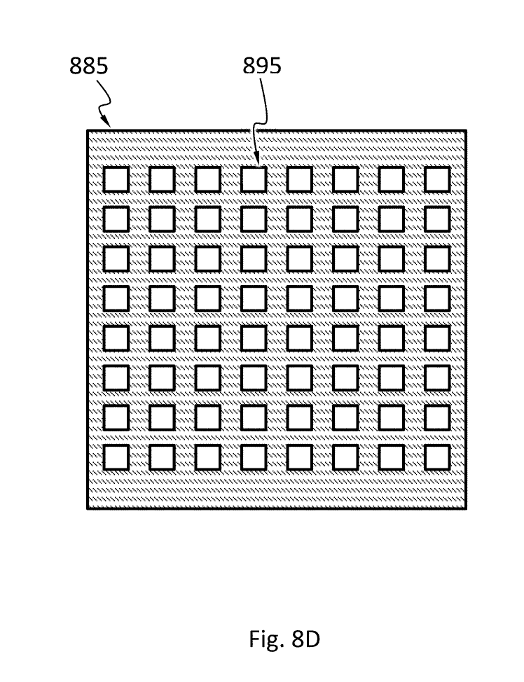

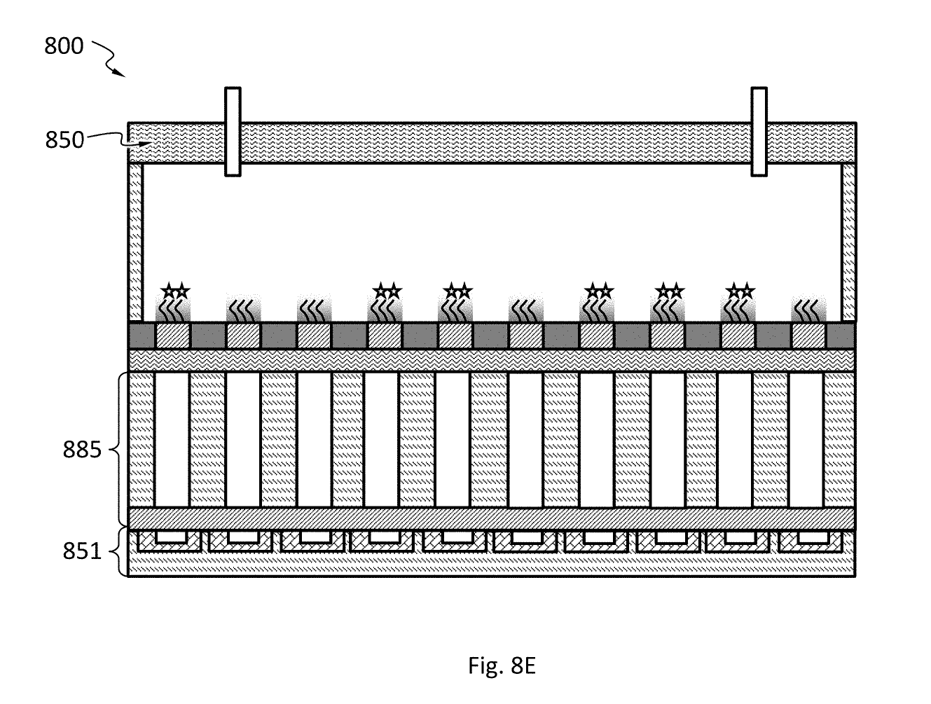

In an embodiment, schematically shown in FIG. 8A, the collimator 695 or 795 may have a core 896 surrounded by a sidewall 897. The sidewall 897 of the collimator 695 or 795 may attenuate (absorb) the portion 673. In the embodiment in FIG. 6, the portion 673 of the signal 658 may enter the collimator 695 but is likely to reach the sidewall 897 before it can reach the pixels 670. The sidewall 897 that can attenuate (absorb) the portion 673 will essentially prevent portion 673 from reaching the pixels 670. In an embodiment, the core 896 may be a void space. Namely, the sidewall 897 surrounds a void space.

In an embodiment, schematically shown in FIG. 8B, the sidewall 897 is textured. For example, the interface 898 between the sidewall 897 and the core 896 (which can be a void space) may be textured. Textured sidewall 897 can help further attenuate light incident thereon.

In an embodiment, schematically shown in FIG. 8C and FIG. 8D, the optical system 885 may have a plurality of collimators 895 arranged in an array. For example, the optical system 885 may have a dedicated collimator 895 for each pixel 870. For example, the optical system 885 may have a collimator 895 shared by a group of pixels 870. The collimator 895 may have any suitable cross-sectional shape, such as circular, rectangular, and polygonal.

In an embodiment, the collimators 895 may be made by etching (by e.g., deep reactive ion etching (deep RIE), laser drilling) holes into a substrate. The sidewall 897 may be made by depositing a material on the sidewall of the holes. The core 896 may be made by filling the holes. Planarization may also be used in the fabrication of the collimators 895.

In an embodiment as schematically shown in FIG. 8E, in apparatus 800, the optical system 885 may have a microfluidic system 850 to deliver reactants such as the analyte and reaction product to and from probes. The microfluidic system 850 may have wells, reservoirs, channels, valves or other components. The microfluidic system 850 may also have heaters, coolers (e.g., Peltier devices), or temperature sensors. The heaters, coolers or temperature sensors may be located in the optical system 885, above or in the collimators 895. The heaters, coolers or temperature sensors may be located above or in the sensor 851. The apparatus 800 may be used for a variety of assays. For example, the apparatus 800 can be used to conduct real-time polymerase chain reaction (e.g., quantitative real-time PCR (qPCR)). Real-time polymerase chain reaction (real-time PCR) detects amplified DNA as the reaction progresses. This is in contrast to traditional PCR where the product of the reaction is detected at the end. One real-time PCR technique uses sequence-specific probes labelled with a fluorophore which fluoresces only after hybridization of the probe with its complementary sequence, which can be used to quantify messenger RNA (mRNA) and non-coding RNA in cells or tissues.

The optical system 885 and the sensor 851 may be fabricated in separate substrates and bonded together using a suitable technique, such as, flip-chip bonding, wafer-to-wafer direct bonding, or gluing.

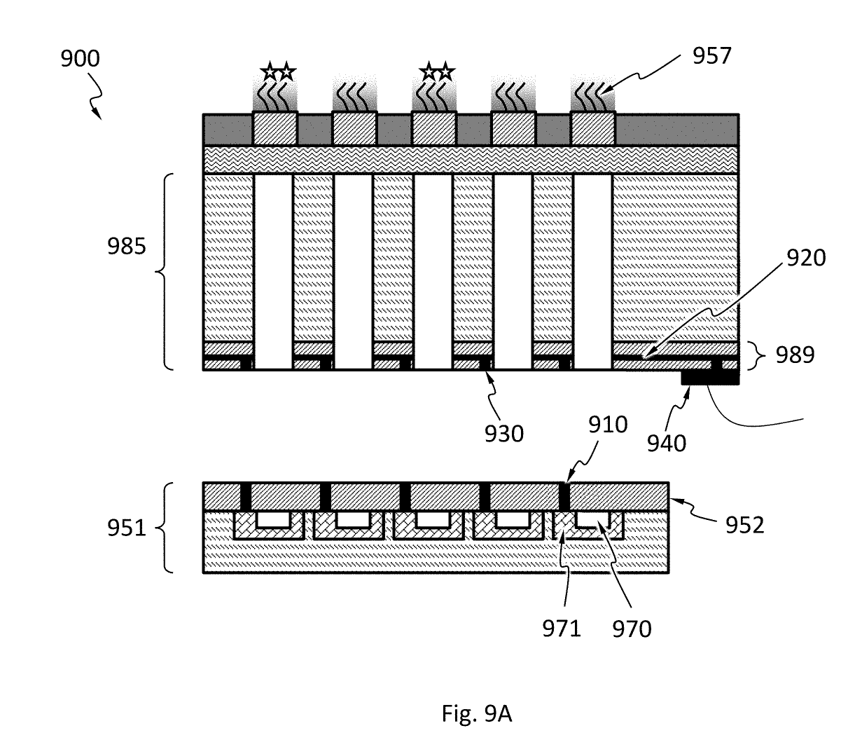

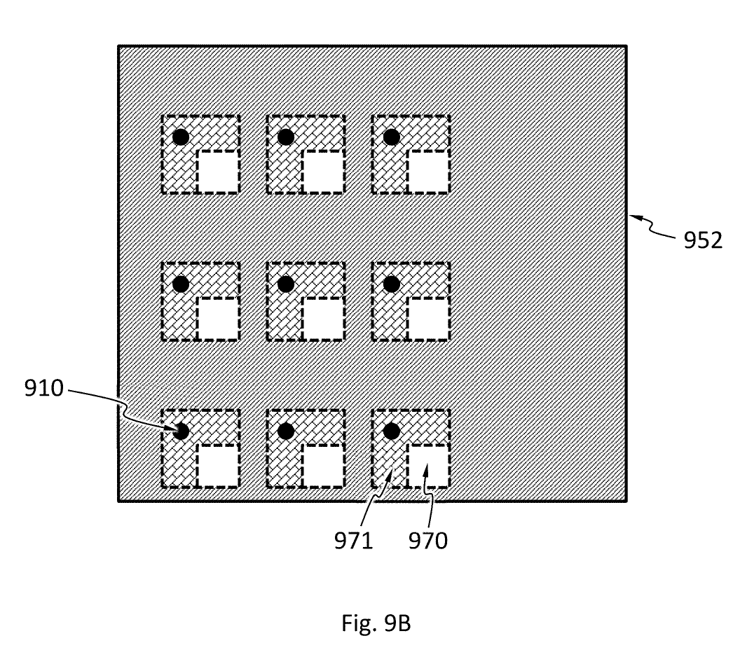

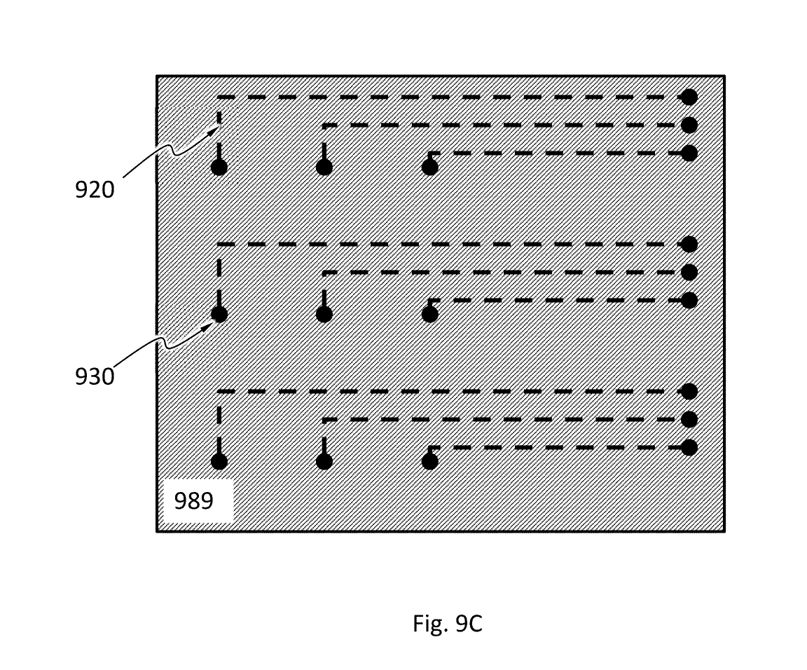

In an embodiment, schematically shown in FIG. 9A, in apparatus 900, the sensor 951 has a signal transfer layer 952. The signal transfer layer 952 may have a plurality of vias 910. The signal transfer layer 952 may have electrically insulation materials (e.g., silicon oxide) around the vias 910. The optical system 985 may have a redistribution layer 989 with transmission lines 920 and vias 930. The transmission lines 920 connect the vias 930 to bonding pads 940. When the sensor 951 and the optical system 985 are bonded, the vias 910 and the vias 930 are electrically connected. This configuration shown in FIG. 9A allows the bonding pads 940 to be positioned away from the probes 957.

FIG. 9B shows a top view of the sensor 951 in FIG. 9A to illustrate the positions of the vias 910 relative to the pixels 970 and the control circuit 971. The pixels 970 and the control circuit 971 are shown in dotted lines because they are not directly visible in this view. FIG. 9C shows a bottom view of the optical system 985 in FIG. 9A to illustrate the positions of the vias 930 relative to the transmission lines 920 (shown as dotted lines because they are not directly visible in this view).

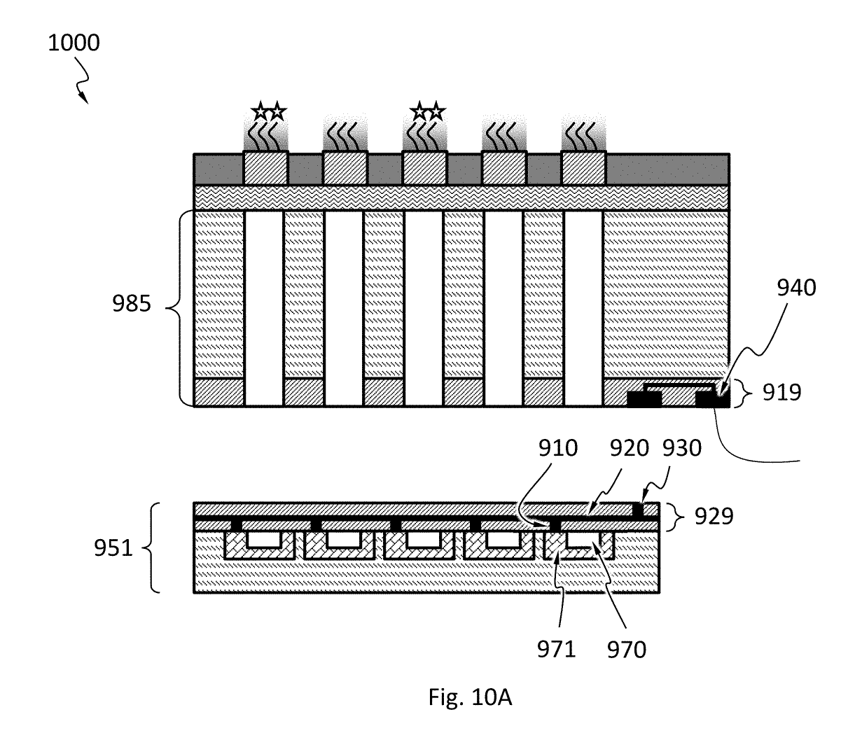

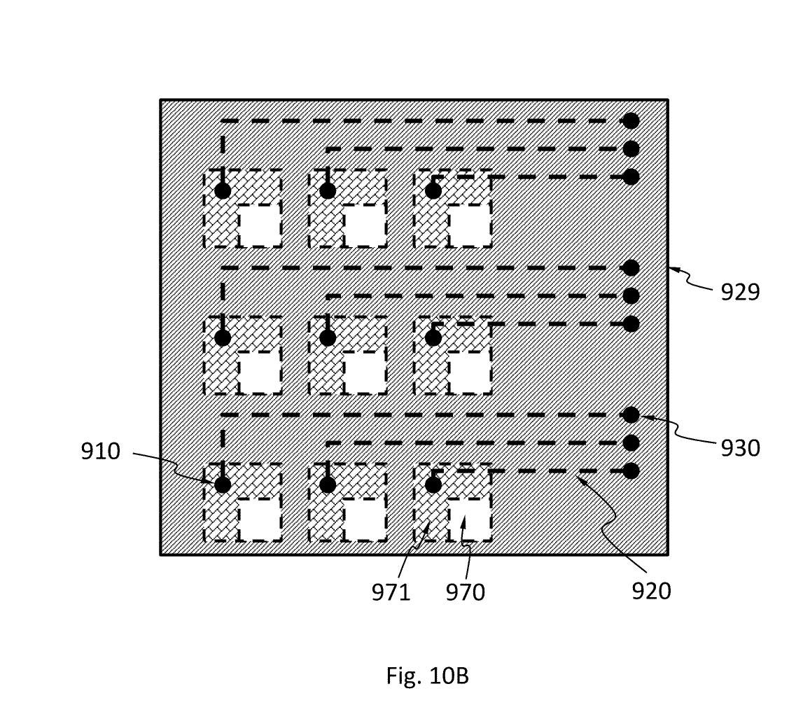

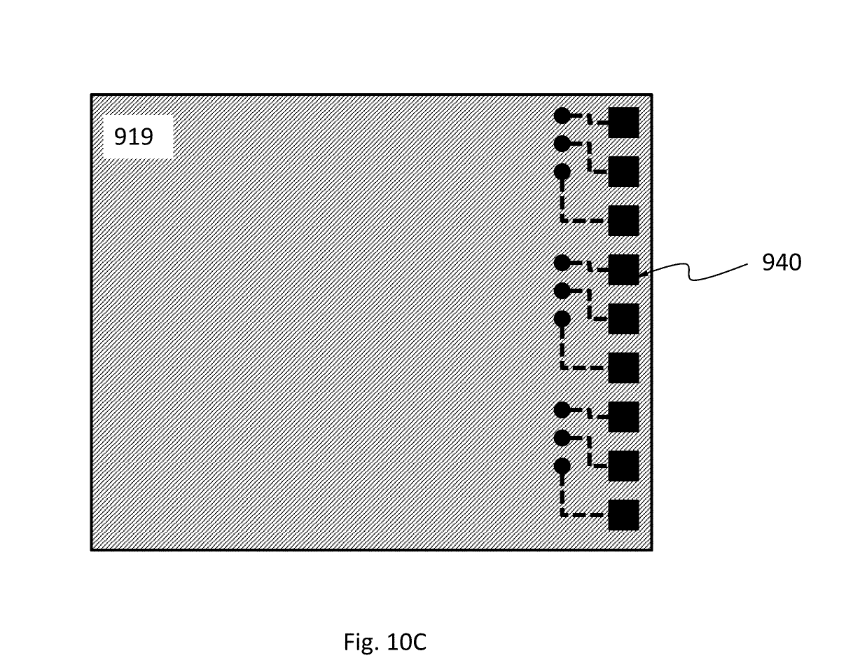

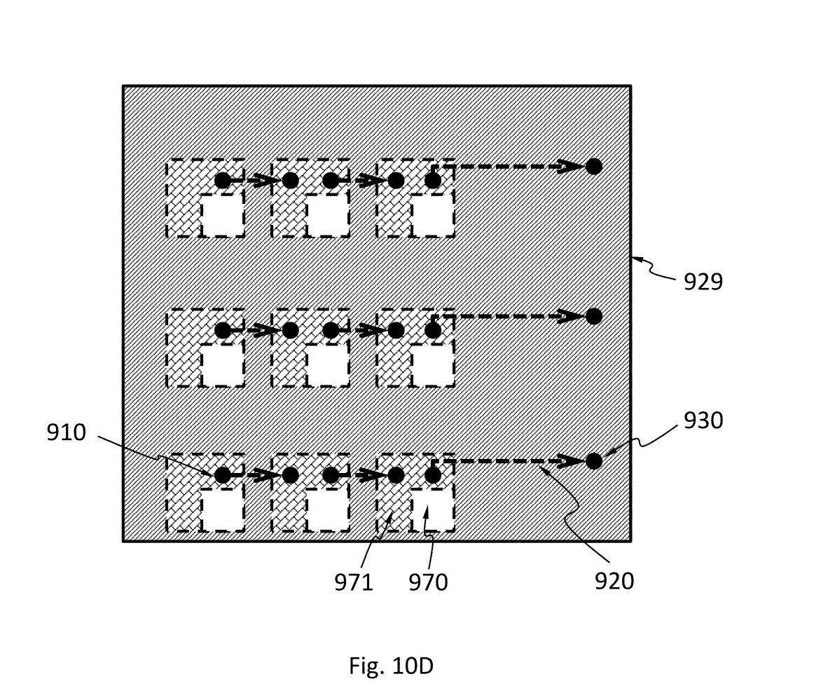

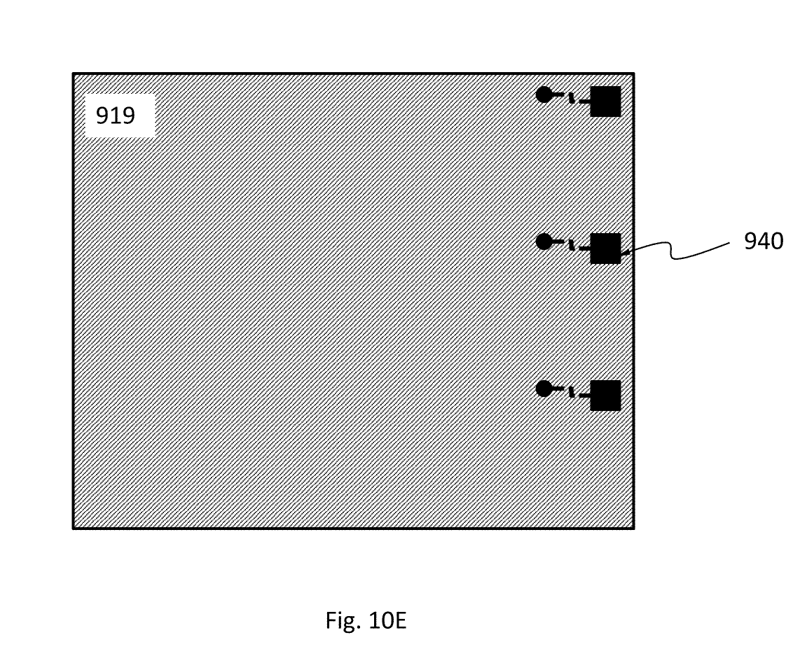

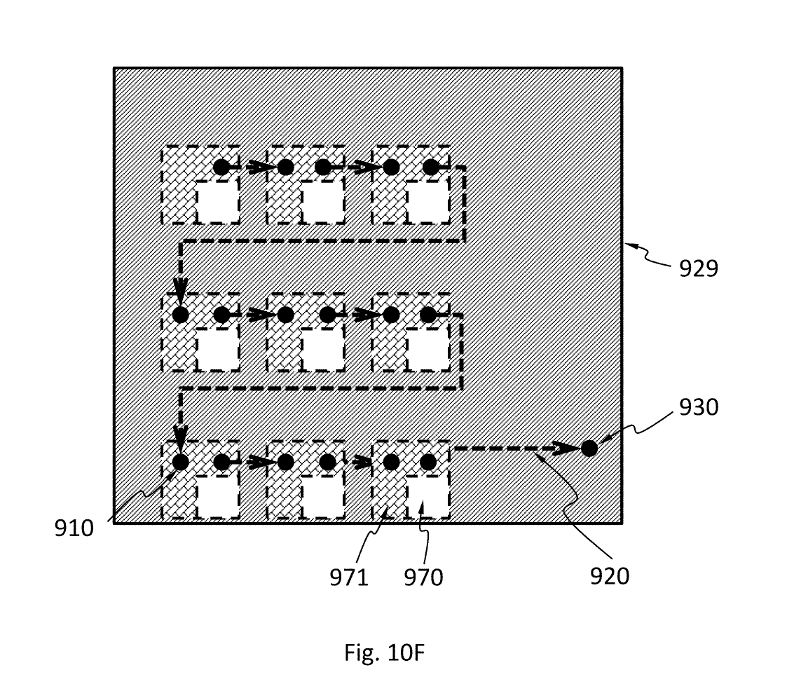

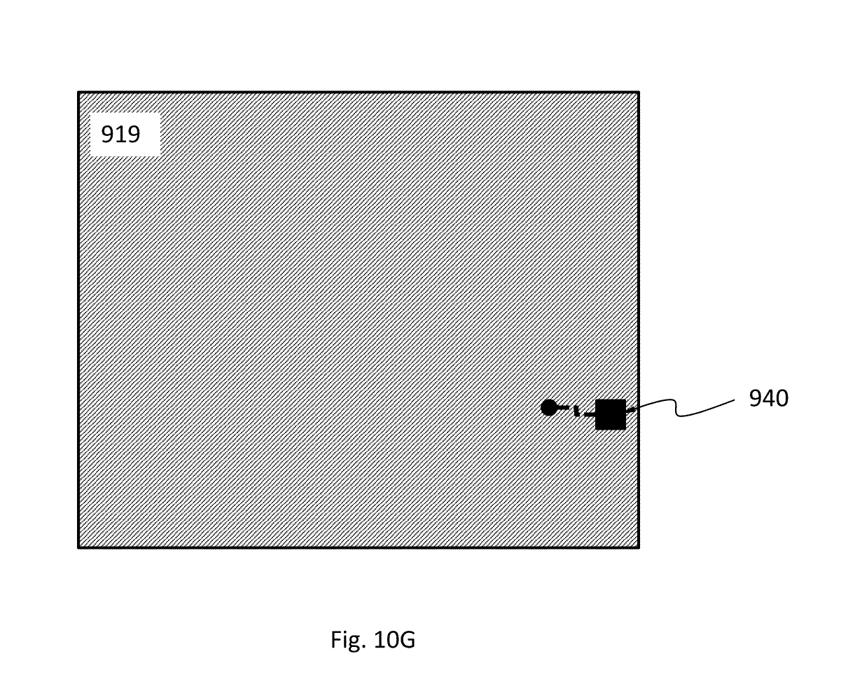

In an embodiment, schematically shown in FIG. 10A, in apparatus 1000, the sensor 951 has a redistribution layer 929. The redistribution layer 929 may have a plurality of vias 910 and a plurality of transmission lines 920. The redistribution layer 929 may have electrically insulation materials (e.g., silicon oxide) around the vias 910 and the transmission lines 920. The vias 910 electrically connect the control circuit 971 to the transmission lines 920. The optical system 985 may have a layer 919 with bonding pads 940. The redistribution layer 929 may also have vias 930 electrically connecting the transmission lines 920 to the bonding pads 940, when the sensor 951 and the optical system 985 are bonded. The bonding pads 940 may have two parts connected by a wire buried in the layer 919. This configuration shown in FIG. 10A allows the bonding pads 940 to be positioned on an opposite side from the probe carrier.

FIG. 10B shows a top view of the sensor 951 in FIG. 10A to illustrate the positions of the vias 910, the vias 930 and the transmission lines 920, relative to the pixels 970 and the control circuit 971, according to an embodiment. The pixels 970, the control circuit 971 and the transmission lines 920 are shown in dotted lines because they are not directly visible in this view. FIG. 10C shows a bottom view of the optical system 985 in FIG. 10A to illustrate the positions of the bonding pads 940, which are positioned to connect to the vias 930 shown in FIG. 10B. The bonding pads 940 may have two parts connected by a wire buried in the layer 919.

FIG. 10D shows a top view of the sensor 951 in FIG. 10A to illustrate the positions of the vias 910, the vias 930 and the transmission lines 920, relative to the pixels 970 and the control circuit 971, according to an embodiment. The pixels 970, the control circuit 971 and the transmission lines 920 are shown in dotted lines because they are not directly visible in this view. The pixels 970 may be read out column by column. For example, signal from one 970 may be stored in register in the control circuit 971 associated with that pixel 970; the signal may be successively shifted from one column to the next, and eventually to other processing circuitry through vias 930. FIG. 10E shows a bottom view of the optical system 985 in FIG. 10A to illustrate the positions of the bonding pads 940, which are positioned to connect to the vias 930 shown in FIG. 10D. The bonding pads 940 may have two parts connected by a wire buried in the layer 919.

FIG. 10F shows a top view of the sensor 951 in FIG. 10A to illustrate the positions of the vias 910, the via 930 and the transmission lines 920, relative to the pixels 970 and the control circuit 971, according to an embodiment. The pixels 970, the control circuit 971 and the transmission lines 920 are shown in dotted lines because they are not directly visible in this view. The pixels 970 may be read out pixel by pixel. For example, signal from one 970 may be stored in register in the control circuit 971 associated with that pixel 970; the signal may be successively shifted from one pixel to the next, and eventually to other processing circuitry through via 930. FIG. 10G shows a bottom view of the optical system 985 in FIG. 10A to illustrate the positions of the bonding pad 940, which are positioned to connect to the via 930 shown in FIG. 10F. The bonding pads 940 may have two parts connected by a wire buried in the layer 919.

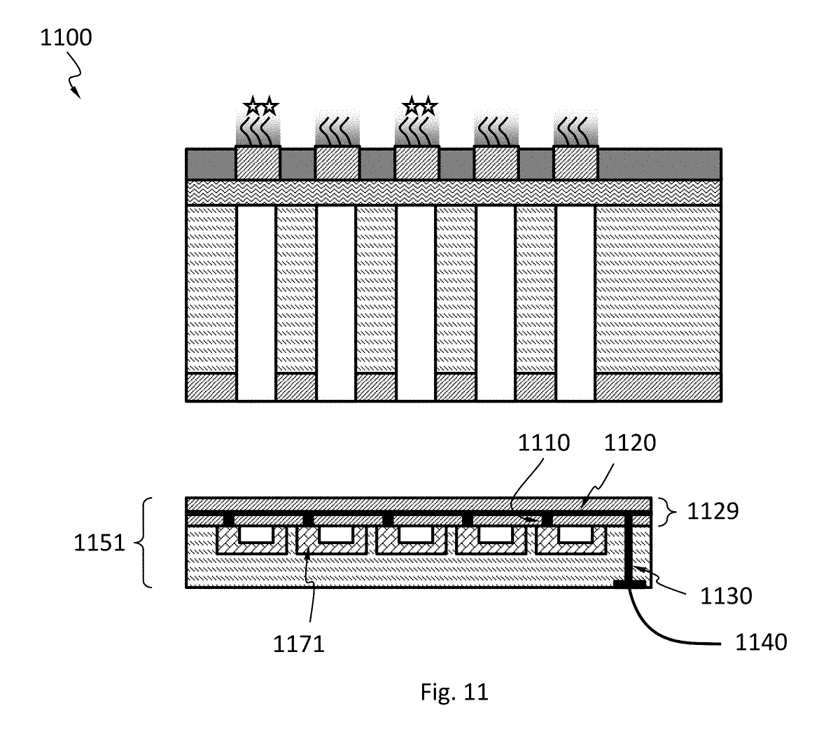

In an embodiment, schematically shown in FIG. 11, in apparatus 1100, the sensor 1151 has a redistribution layer 1129. The redistribution layer 1129 may have a plurality of vias 1110 and a plurality of transmission lines 1120. The redistribution layer 1129 may have electrically insulation materials (e.g., silicon oxide) around the vias 1110 and the transmission lines 1120. The vias 1110 electrically connect the control circuit 1171 to the transmission lines 1120. The redistribution layer 1129 may also have vias 1130 (e.g., through-silicon vias (TSV)) electrically connecting the transmission lines 1120 to bonding pads 1140 on the side opposite from the redistribution layer 1129. This configuration shown in FIG. 11 allows the bonding pads 1140 to be positioned on an opposite side from the probe carrier.

The probe carrier 200 may be integrated into a total internal reflection fluorescence microscope (TIRFM). The TIRFM has a lens 1220 that may be positioned on the side of the substrate 201 opposite to the probes. The lens 1220 may be immersed in a drop of oil 1210 to increase the numerical aperture. Collimators such as 695 may be omitted because the optical system of the TIRFM may be configured to block light that is not parallel to the optical axis, for example, by an aperture at the pupil plane.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An apparatus comprising:
a probe carrier comprising a plurality of optical waveguides supported on a substrate;
an optical system comprising a plurality of collimators;
wherein each of the plurality of optical waveguides is optically decoupled from another of the plurality of optical waveguides;
wherein each of the plurality of optical waveguides comprises a surface comprising sites configured to attach a probe;
wherein the collimators are configured to essentially prevent light from passing if a deviation of a propagation direction of the light from an optical axis of the collimators is greater than a threshold.

2. The apparatus of claim 1, wherein a refractive index of at least one of the plurality of optical waveguides is greater than a refractive index of water.

3. The apparatus of claim 1, wherein two of the plurality of optical waveguides have different reflective indexes.

4. The apparatus of claim 1, wherein two of the plurality of optical waveguides have same reflective indexes.

5. The apparatus of claim 1, wherein cross-sectional shape of the plurality of optical waveguides is a rectangle, a square, a triangle, of a semi-circle.

6. The apparatus of claim 1, wherein the plurality of optical waveguides are parallel to one another.

7. The apparatus of claim 1, wherein space among the optical waveguides is filled with a material.

8. The apparatus of claim 1, wherein the plurality of optical waveguides comprise a material selected from a group consisting of: glass, quartz, diamond, an organic polymer, and a composite thereof.

9. The apparatus of claim 1, wherein the sites are configured to directly attach to the probe through physical adsorption, chemical crosslinking, electrostatic adsorption, hydrophilic interaction or hydrophobic interaction.

10. The apparatus of claim 9, wherein the probe is selected from a group consisting of fluorescently proteins, peptides, oligonucleotides, cells, bacteria, and nucleic acids.

11. The apparatus of claim 10, wherein the probe comprises an internal luminophore.

12. The apparatus of claim 1, wherein the substrate comprises silicon.

13. (canceled)

14. The apparatus of claim 1, comprising a sensor which comprises a plurality of pixels configured to detect a signal generated by the apparatus.

15. The apparatus of claim 14, wherein the sensor comprises a control circuit configured to control, acquire data from, or process data from the pixels.

16. The apparatus of claim 14, wherein the pixels are arranged such that at least one of the pixels is optically coupled to each of the sites.

17. The apparatus of claim 14, wherein the pixels are optically coupled to the sites by the collimators.

18. The apparatus of claim 14, wherein the signal is luminescence.

19. The apparatus of claim 14, wherein the signal is generated under excitation of an excitation radiation.

20. The apparatus of claim 1, wherein the optical system further comprises a plurality of microlens.

21. The apparatus of claim 14, wherein the collimators are configured to eliminate optical cross-talk between neighboring pixels among the plurality of pixels.

22. The apparatus of claim 14, wherein at least one of the collimators comprises a core and a sidewall surrounding the core.

23. The apparatus of claim 22, wherein the signal is generated under excitation of an excitation radiation; wherein the core is a material that essentially prevents the excitation radiation from passing through irrespective of propagation direction of the excitation radiation.

24. The apparatus of claim 22, wherein the core allows the signal to pass through essentially unabsorbed.

25. The apparatus of claim 22, wherein the core is a void space.

26. The apparatus of claim 22, wherein the sidewall attenuates a portion of the signal reaching the sidewall.

27. The apparatus of claim 22, wherein the sidewall is textured.

28. The apparatus of claim 14, wherein the pixels are arranged in an array and are configured to be read out column by column.

29. The apparatus of claim 14, wherein the pixels are arranged in an array and are configured to be read out pixel by pixel.

30. A total internal reflection fluorescence microscope (TIRFM) comprising the apparatus of claim 1.
